(19) United States
(12) Patent Application Publication
(10) Pub. No.: US 2009/0263990 A1
(43) Pub. Date: Oct. 22, 2009

(54) Connector assembly having connecting device

(75) Inventors: Robert W. Brown, Harrisburg, PA (US); Tod M. Harlan, Mechanicsburg, PA (US); Kevin E. Walker, Hershey, PA (US); Terrance F. Little, York, PA (US)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECESION IND. CO., LTD.

(21) Appl. No.: 12/148,279

(22) Filed: Apr. 17, 2008

(51) Int. Cl. H01R 12/04

(52) U.S. Cl. 439/78

(57) ABSTRACT

A connector assembly includes a mother board (12), a mother receptacle (11), a daughter board (22), a daughter receptacle (21), and a connecting device (30) mounted between said two boards. The connecting device includes a number of fixing portions, a shroud (31) defining an insertion slot (313) and engageable with said two boards via the fixing portions, and an extender (32) inserted in the insertion slot. The extender defines a lower opening (322) mating with the mother receptacle and an upper opening (321) mating with the daughter receptacle.

### BACKGROUND OF THE INVENTION

1. Field of the Invention

The present invention relates to a connector assembly, and particularly to a connector assembly having a connecting device between a pair of separated circuit boards.

2. Description of Related Art

Conventional board-to-board connector assembly has a plurality of standard commercial hexagonal rivets positioned between an upper circuit board and a lower circuit board for supporting the upper board and maintaining a certain distance between the two separated boards. The rivet has opposite ends respectively engaging with the pair of separated circuit boards.

When an unpackaged drop test is performed on the connector assembly, the rivets may be not mechanically strong enough to withstand the strong pressing force produced from the drop test. The connection between the two circuit boards has been broken finally.

Hence, an improved connector assembly is required to overcome the above-mentioned disadvantages of the related art.

### SUMMARY OF THE INVENTION

An object of the present invention is to provide a connector assembly having a reinforced connecting device for providing a reliable connection between a pair of separated circuit boards.

To achieve the aforementioned objects, a connector assembly comprises a mother board, a mother receptacle mount on the mother board, a daughter board, a daughter receptacle mounted on the daughter board, and a connecting device mounted between said two boards. The connecting device comprises a plurality of fixing portions, a shroud defining an insertion slot and engageable with said two boards via the fixing portions, and an extender inserted in the insertion slot. The extender defines a lower opening mating with the mother receptacle and an upper opening mating with the daughter receptacle.

The connecting device is reinforced as a rigid strengthened structure by integrating the shroud and the extender as a single piece. The connecting device is thus capable of providing a reliable connection between the mother board and the daughter board. Therefore, the mother board and the daughter board could be restricted from shifting with respect to each other during an unpackaged drop test to thereby meet the requirement of the customer. Additionally, the connecting device could be designed with a proper height to separate the daughter board from the mother board at a required distance.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is an assembled perspective view of a connector assembly in accordance with the present invention;

FIG. 2 is an exploded perspective view of the connector assembly as shown in FIG. 1;

FIG. 3 is an exploded perspective view of a connecting device as shown in FIG. 2;

FIG. 4 is another exploded perspective view similar to FIG. 3, taken from another aspect;

FIG. 5 is a partially assembled perspective view of the connecting device as shown in FIG. 3, with the contact modules being removed; and

FIG. 6 is a perspective view showing the connecting device mounted on a mother board.

### DETAILED DESCRIPTION OF THE INVENTION

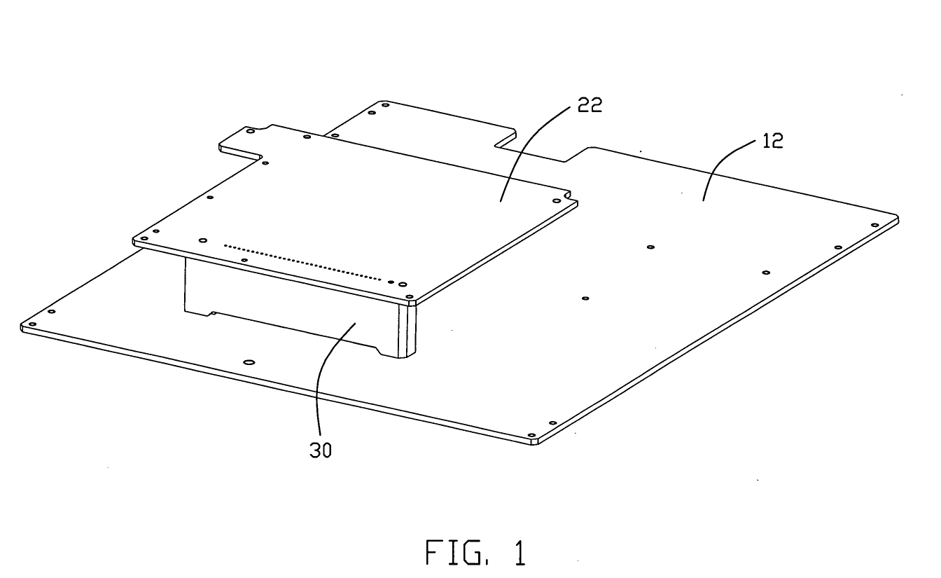

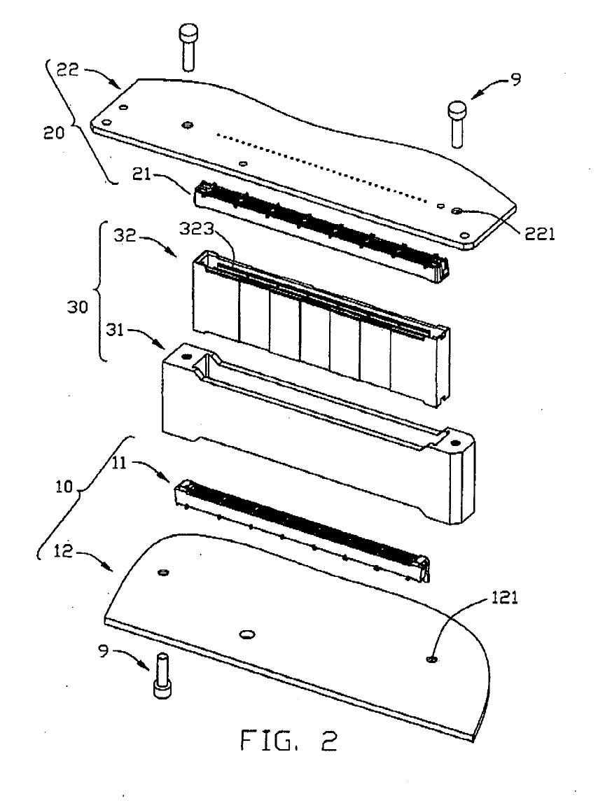

Reference will now be made to the drawing figures to describe the present invention in detail. Referring to FIGS. 1-2, a connector assembly in accordance with the preferred embodiment of the present invention comprises a mother system 10, a daughter system 20, and a connecting device 30. The mother system 10 comprises a mother board 12 and a mother receptacle 11 mounted on the mother board 12. The daughter system 20 comprises a daughter board 22 and a daughter receptacle 21 mounted on the daughter board 22. The connecting device 30 is disposed between the mother board 12 and the daughter board 22.

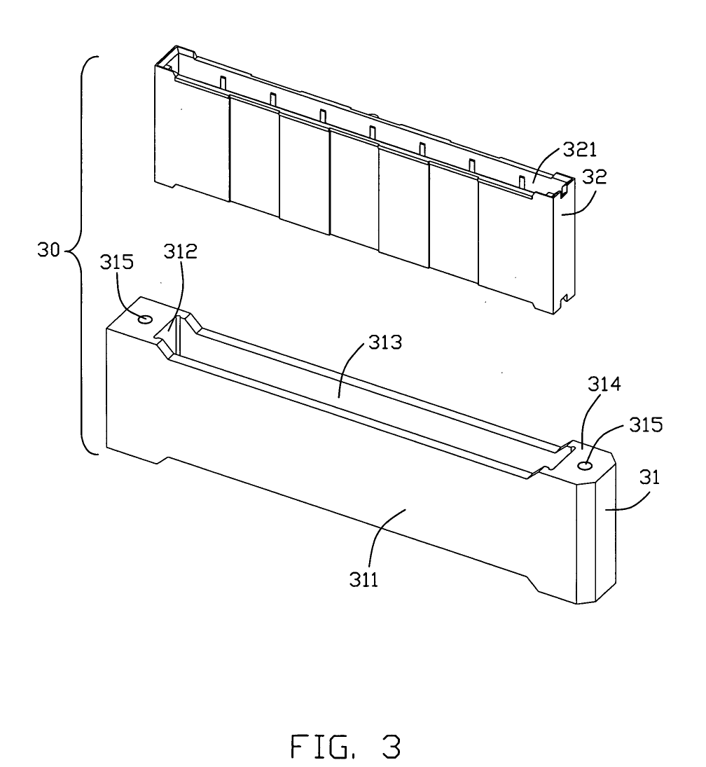

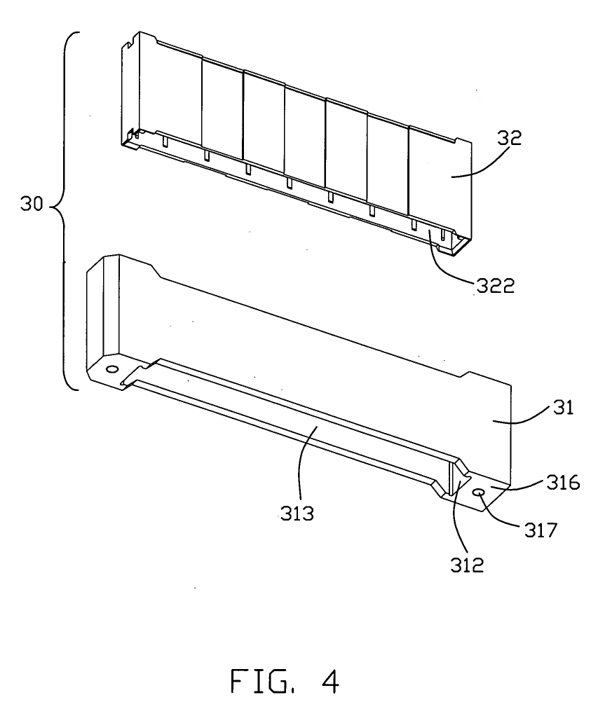

Referring to FIGS. 2-4, the connecting device 30 comprises a plurality of screws (not shown), a shroud 31 defining an insertion slot 313 and an extender 32 inserted in the insertion slot 313. The shroud 31 comprises a pair of primary walls 311 and a pair of combined walls 312 interconnected together for surrounding the insertion slot 313. Each combined wall 312 has a top face 314 defining an upper taped hole 315 and a bottom face 316 defining a lower taped hole 317.

The rectangular extender 32 has an upper opening 321 and a lower opening 322 communicating with the upper opening 321. The extender 32 has a pair of contact modules 323 retained therein. Each contact module 323 has a lower end and an upper end respectively disposed in the lower and upper openings 322, 321.

Referring to FIG. 2, the mother board 12 defines a pair of first fixing holes 121 through the mother board 12. The daughter board 22 parallel to the mother board 12 and defines a pair of second fixing holes 221 through the daughter board 22.

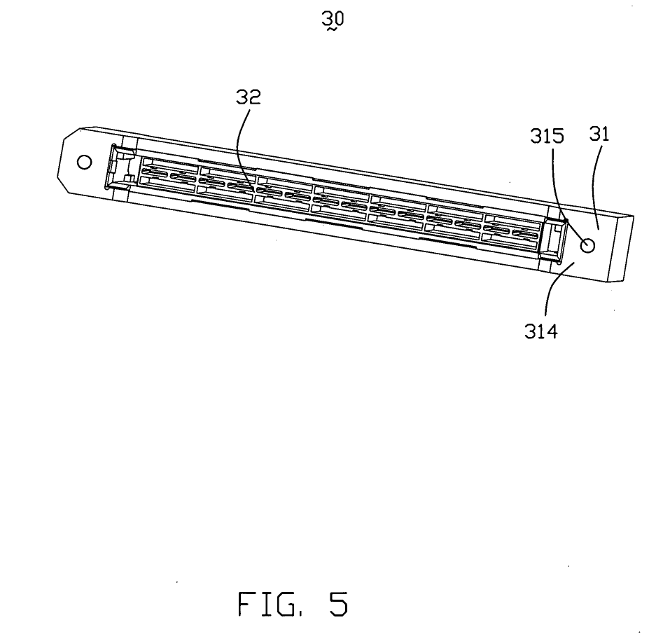

In conjunction with FIG. 5, in assembly of the connecting device 30, the extender 32 is inserted into the insertion slot 313 of the shroud 31, with an outer surface of the extender 32 attached to inner surfaces of the primary walls 311 and the combined walls 312.

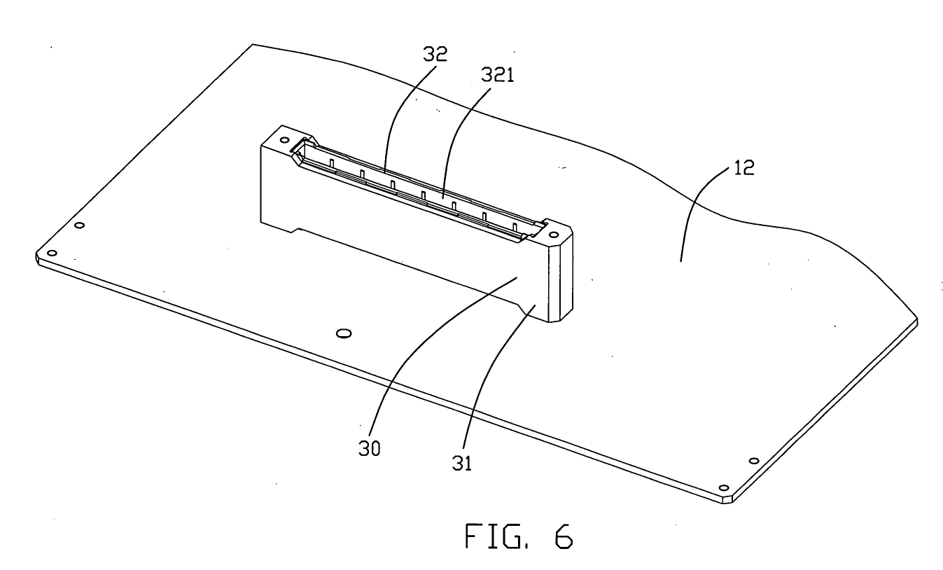

In conjunction with FIG. 6, the connecting device 30 is mounted on the mother board 12 firstly, with the mother receptacle 11 inserted into the lower opening 322 of the extender 32. The connecting device 30 is fastened to the mother board 12, via a pair of screws each inserted upwardly through the first fixing hole 121 of the mother board 12 and engaging with the lower tapped hole 317 of the shroud 31.

Referring to FIG. 1, the daughter board 22 together with the daughter receptacle 21 is then mated with the connecting device 30, with the daughter receptacle 21 retained within the upper opening 321 of the extender 32. The connecting device 30 is fastened to the daughter board 22, via a pair of screws each inserted downwardly through the second fixing hole 221 of the daughter board 22 and engaging with the upper tapped hole 315 of the shroud 31. The mother board 12 together with the mother receptacle 11 and the daughter board 22 together with the daughter receptacle 21 are electrically connected with each other, via the contact modules 323 disposed in the lower and upper openings 321, 322 for mating with the mother and daughter receptacles 11, 21. Optionally, the screws could be replaced by other fixing portions, if only it could engage with one board and the connecting device 30 simultaneously.

The connecting device 30 is reinforced as a rigid strengthened structure by integrating the shroud 31 and the extender 32 as a single piece. Thus, the connecting device 30 is capable of providing a reliable connection between the mother board 12 and the daughter board 11. Therefore, the mother board 12 and the daughter board 22 are restricted from shifting with respect to each other during an unpackaged drop test to thereby meet the requirement of the customer. Additionally, the connecting device 30 could be designed with a proper height to separate the daughter board 22 from the mother board 12 at a required distance.

However, the disclosure is illustrative only, changes may be made in detail, especially in matter of shape, size, and arrangement of parts within the principles of the invention.

1-10. (canceled)

11. A connection system comprising:
first and second printed circuit boards opposite to each other in a parallel relation;
a first connector mounted upon one surface of the first printed circuit board;
a second connector mounted upon one surface of the second printed circuit board facing to said first connector;
a connection device located between said first connector and said second connector and defining opposite mating ports respectively coupled to the first and second connectors; and
a frame structure dimensioned with a height similar to that of the connection device and enclosing said connection device, said frame structure including two pairs of abutment faces, at two longitudinal ends thereof, respectively seated upon the surface of the first printed circuit board and the surface of the second printed circuit board; wherein
most forces derived from the printed circuit boards due to fastening the printed circuit board and the frame structure are absorbed by said frame rather than the connectors and the connection device.

12. The connection system as claimed in claim 11, wherein both said first printed circuit board and said second printed circuit board are vertically exposed outside of the frame structure and extend laterally beyond a transverse contour of said frame structure.

13. The connection system as claimed in claim 11, wherein the first and second boards are fastened to the frame structure via screws.

14. The connection system as claimed in claim 11, wherein said frame structure defines four side walls enclosing a through cavity therein to protectively receive at least said connection device.

15. The connection system as claimed in claim 14, wherein said frame structure essentially further at least partially encloses both said first connector and said second connector.
